(19) United States
(12) Patent Application Publication
(10) Pub. No.: US 2020/0324815 A1
(43) Pub. Date: Oct. 15, 2020

(54) SMART CONTROLLER

(71) Applicants: Hyundai Motor Company, Seoul (KR); Kia Motors Corporation, Seoul (KR)

(72) Inventors: Jae Hyeong Cho, Hwaseong (KR); Yeon Ji Kang, Suwon (KR); Pill Yoon Kim, Uiwang (KR); Jae Min Park, Namyangju (KR)

(21) Appl. No.: 16/848,237

(22) Filed: Apr. 14, 2020

Related U.S. Application Data
(60) Provisional application No. 62/834,360, filed on Apr. 15, 2019.

(30) Foreign Application Priority Data
Apr. 2, 2020 (KR) 10-2020-0040431

(51) Int. Cl. B62D 15/02; B60W 60/00

(52) U.S. Cl. CPC B62D 15/0215; B60W 60/0011

(57) ABSTRACT

A smart controller for vehicles disposed around a steering column of a vehicle to control various functions of the vehicle is provided. The smart controller includes a support unit protruding from the steering column in a first direction, a connection unit extending from the support unit in a second direction, and a manipulation unit mounted to the connection unit and disposed in a third direction. The manipulation unit includes a plurality of manipulators each configured to receive user input necessary to execute a specific function of a vehicle while mounted to the connection unit or being separated from the connection unit. The support unit protrudes in the X-axis direction, the connection unit extends in the Z-axis direction, and the manipulation unit is disposed in the Y-axis direction.

### CROSS-REFERENCE TO RELATED APPLICATION(S)

This application claims the benefit of Korean Patent Application No. 10-2020-0040431, filed on Apr. 2, 2020, which is hereby incorporated by reference as if fully set forth herein. This application also claims the benefit of U.S. Provisional Application No. 62/834,360, filed on Apr. 15, 2019, the contents of which are hereby incorporated by reference in their entirety.

### BACKGROUND

### Field of the Invention

The present invention relates to a smart controller for vehicles, and more particularly to a smart controller for vehicles disposed around a steering column of a vehicle to execute various functions of the vehicle.

### Discussion of the Related Art

A future multimedia artificial intelligence vehicle may be realized using fusion technology capable of providing a safer vehicle as and more comfortable advanced mobile space through fusion of the vehicle and electric, electronic, and information communication technology, using information communication technology capable of evolving a vehicle as an advanced information device, and using tangible and intangible multimedia information technology corresponding thereto.

In addition, safety and security technology and intelligent technology may be enhanced as multimedia technology based on a vehicle network, whereby a vehicle may more conveniently provide final infotainment to a driver. Such evolution of the vehicle inevitably leads to development of technology capable of transmitting information to the driver.

Meanwhile, a driver information system (DIS), which is network technology for vehicles capable of interconnecting various multimedia devices and an electronic controller using digital technology, may operate various multimedia devices and execute various functions of a vehicle using a single monitor. For the driver information system, a plurality of control buttons used in a vehicle has been replaced with a jog dial to simplify a user interface (UI) in recent years.

As the number of control menus has been gradually increased, however, a larger number of control buttons has been required to control a larger number of functions. Consequently, when the control buttons are not efficiently disposed or when a vehicle controller including a plurality of control buttons has a complex structure, convenience and safety of the driver may be deteriorated. Therefore, there is a need to develop a smart controller for vehicles capable of improving convenience and safety of the driver when executing various functions of a vehicle.

### SUMMARY

Accordingly, the present invention provides a smart controller that substantially obviates one or more problems due to limitations and disadvantages of the related art. An object of the present invention is to provide a smart controller for vehicles with a plurality of manipulators disposed around a steering column of a vehicle, whereby it may be possible for a driver to conveniently and safely control various functions of the vehicle.

Objects of the present invention devised to solve the problems are not limited to the aforementioned object, and other unmentioned objects will be clearly understood by those skilled in the art based on the following detailed description of the present invention.

To achieve these objects and other advantages and in accordance with the purpose of the invention, a smart controller may include a support unit that protrudes from the steering column in a first direction, a connection unit that extends from the support unit in a second direction, and a manipulation unit mounted to the connection unit. The manipulation unit may be disposed in a third direction and may include a plurality of manipulators. Each manipulator may be configured to receive user input necessary to execute a specific function of a vehicle in the state of being mounted to the connection unit or being separated from the connection unit.

The support unit may protrude in the X-axis direction, the connection unit may extend in the Z-axis direction, and the manipulation unit may be disposed in the Y-axis direction. The support unit may be disposed at the rear of a steering wheel disposed at the end of the steering column to protrude in the state of being inclined toward the steering wheel. A direction switching unit configured to rotate the support unit such that the support unit is folded rearwards or unfolded forwards may be disposed at a connection area between the support unit and the steering column.

The support unit may include a plurality of support bars that protrude from the steering column, and the support bars may be disposed in symmetry. The front surface of the connection unit, at which the manipulation unit is disposed, may be a curved surface having a radius of curvature that is curved rearwards. The side surface of the connection unit that faces the steering column may be a curved surface having a radius of curvature that is curved outwards.

A direction switching unit configured to rotate the manipulators in the horizontal and vertical (leftward/rightward/upward/downward) directions may be further disposed at the area of the connection unit to which the manipulators are mounted. The plurality of manipulators may be arranged along the front surface of the connection unit at predetermined intervals. Each manipulator may include a first switch disposed at the front thereof, a second switch located around the first switch, and a housing configured to wrap or surround the first and second switches.

The first and second switches may be different types of user input switches. Each manipulator may include a plurality of user input buttons arranged differently based on user settings. Depending on circumstances, each manipulator may include a plurality of user input buttons arranged in different sizes depending on priority.

In another case, the user input buttons may replace user input buttons included in other manipulators that are unable to be used. In a further case, when one of the user input buttons is selected, a first function of the vehicle that corresponds to the selected input button may be executed, and when at least two of the user input buttons are simultaneously selected, a second function of the vehicle that corresponds to the simultaneously selected input buttons may be executed. Each manipulator may include a communication unit configured to communicate with another manipulator, and may be configured to transmit or receive information to or from another manipulator via the communication unit.

In another aspect of the present invention, a vehicle may include a steering column, a steering wheel disposed at the end of the steering column, and a smart controller connected to the steering column, the smart controller being disposed around the steering wheel. The smart controller may include a support unit that protrudes from the steering column in the first direction, a connection unit that extends from the support unit in the second direction, and a manipulation unit mounted to the connection unit, the manipulation unit being disposed in the third direction. The manipulation unit may include a plurality of manipulators, each manipulator being configured to receive user input necessary to execute a specific function of the vehicle in the state of being mounted to the connection unit or being separated from the connection unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIGS. 1 to 3 are views illustrating a smart controller for vehicles according to an exemplary embodiment of the present invention;

FIGS. 4 to 6 are views illustrating a support unit of the smart controller for vehicles according to an exemplary embodiment of the present invention;

FIG. 7 is a view illustrating a process of fastening between the support unit and a connection unit of the smart controller for vehicles according to an exemplary embodiment of the present invention;

FIGS. 8 and 9 are views illustrating the connection unit of the smart controller for vehicles according to an exemplary embodiment of the present invention;

FIG. 10 is a view illustrating a manipulation unit of the smart controller for vehicles according to an exemplary embodiment of the present invention;

FIGS. 11A to 11F are views showing manipulators configured to control various functions of a vehicle according to an exemplary embodiment of the present invention;

FIGS. 12 to 17 are views illustrating manipulation modes of the manipulators according to an exemplary embodiment of the present invention;

FIG. 18 is a view illustrating a communication process between the manipulators according to an exemplary embodiment of the present invention; and

FIG. 19 is a view illustrating a vehicle including a smart controller for vehicles according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will now be made in detail to the exemplary embodiments of the present invention, examples of which are illustrated in the accompanying drawings. The following embodiments are given by way of example in order to enable those skilled in the art to fully understand the idea of the present invention. Therefore, the present invention is not limited by the following exemplary embodiments, and may be realized in various other forms. In order to clearly describe the present invention, parts having no relation with the description of the present invention have been omitted from the drawings. Wherever possible, the same reference numerals will be used throughout the specification to refer to the same or like parts.

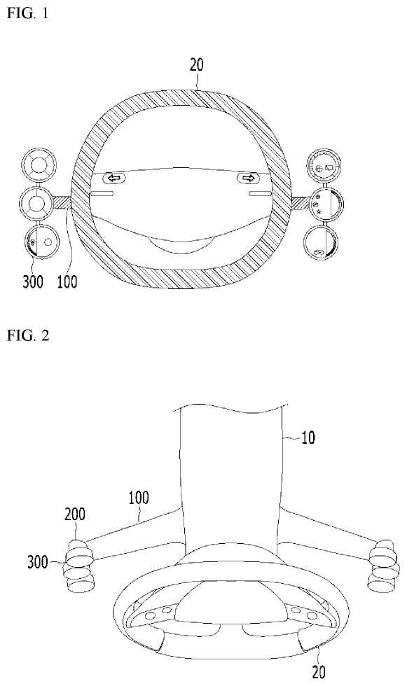

Hereinafter, a smart controller for vehicles and a vehicle including the same, which may be applied to exemplary embodiments of the present invention, will be described in detail with reference to FIGS. 1 to 19.

FIGS. 1 to 3 are views illustrating a smart controller for vehicles according to an exemplary embodiment of the present invention, wherein FIG. 1 is a view showing the front of the smart controller for vehicles, FIG. 2 is a view showing the top of the smart controller for vehicles, and FIG. 3 is an exploded view of the smart controller for vehicles. As shown in FIGS. 1 to 3, the smart controller for vehicles according to the present invention may include a support unit 100, a connection unit 200, and a manipulation unit 300.

In particular, the support unit 100 may protrude from a steering column 10 in a first direction, the connection unit 200 may extend from the support unit in a second direction, and the manipulation unit 300 may be mounted to the connection unit 200 while being disposed in a third direction. In other words, the support unit 100, the connection unit 200, and the manipulation unit 300 may be disposed in different directions. As an example, the support unit 100 may protrude in the X-axis direction, the connection unit 200 may extend in the Z-axis direction, and the manipulation unit 300 may be disposed in the Y-axis direction, but the present disclosure is not limited to those specific directions.

The support unit 100 may be disposed at the rear of a steering wheel 20 disposed at the end of the steering column 10 to protrude in the state of being inclined toward the steering wheel 20. A plurality of manipulators of the manipulation unit 300 may be disposed concentrically toward a driver, whereby the driver may more easily and conveniently manipulate the manipulators, visibility of information displayed on the manipulators may be improved, and safety may be improved.

As an example, the support unit 100 may protrude while being inclined such that the angle between the side surface of the support unit 100 that faces the steering wheel 20 and the outer surface of the steering column 10 is an acute angle. However, the present invention is not limited thereto. In addition, the support unit 100 may have the shape of a bar having a width that gradually increases toward the steering column 10. Accordingly, the support unit 100 may be stably fixed to the steering column 10 even when external impact is applied, whereby displacement or bending of the support unit 100 may be prevented.

In addition, a direction switching unit configured to rotate the support unit 100 such that the support unit 100 is folded rearwards or unfolded forwards may be disposed at a connection area between the support unit 100 and the steering column 10. In particular, when the driver does not directly perform manual driving or when control of vehicle functions through the manipulators is not necessary, the support unit 100 may be folded rearwards to secure driving space and prevent damage to the smart controller. As an example, the support unit 100 may be folded rearwards by the direction switching unit when the vehicle is in an autonomous traveling mode. Here, the direction switching unit may be operated in response to a driver input control single or an automatic control signal that corresponds to the autonomous traveling mode.

Further, the support unit 100 may be folded such that the side surface of the support unit 100 and the outer surface of the steering column 10 face each other when being folded rearwards. However, the present invention is not limited thereto. In addition, the support unit 100 may have at least one separation surface, from which a body thereof is separated when specific force is applied from the outside. In particular, in the support unit 100, the separation surface of the body may be curved when the body is separated. The support unit 100 may have the shape of a bar that protrudes outwards and therefore when the support unit is broken by external impact, the driver may be injured if the broken surface is sharp or the cut surface is rough.

In addition, a fastening protrusion configured to be fastened to the connection unit 200 may be formed at one end of the support unit 100. However, the present invention is not limited thereto. The fastening protrusion may be inserted into and coupled to a fastening recess of the connection unit 200. In addition, the end of the support unit 100 fastened to the connection unit 200 may be exposed to prevent overlap with the steering wheel 20 connected to the steering column 10.

When the end of the support unit 100 fastened to the connection unit 200 overlaps the steering wheel 20 connected to the steering column 10, the manipulators of the manipulation unit 300 are disposed adjacent to the steering wheel 20, whereby driver convenience of manipulating the manipulators may be deteriorated. As an example, the length of the support unit 100 may be greater than the radius of the steering wheel 20. Accordingly, the manipulators of the manipulation unit 300 disposed at the connection unit 200 fastened to the end of the support unit 100 may be arranged to optimize driver convenience.

In addition, the support unit 100 may include a plurality of support bars that protrude from the steering column 10. In particular, the support bars may be disposed in symmetry. The manipulators disposed at the connection unit 200 fastened to the end of the support unit 100 may be located within a front view range of the driver, and therefore, the driver may more easily and comfortably recognize the manipulators. For example, the support unit 100 may include a first support bar that protrudes from the steering column 10 in the leftward direction and a second support bar that protrudes from the steering column 10 in the rightward direction. The first and second support bar may be symmetrical to each other.

Further, a fastening recess may be formed in the side surface of the connection unit 200 fastened to the support unit 100. However, the present invention is not limited thereto. In particular, the fastening protrusion formed at one end of the support unit 100 may be inserted into and coupled to the fastening recess. The connection unit 200 may be disposed in a direction perpendicular to the protruding direction of the support unit 100, and the front surface or the side surface of the connection unit 200 may be flat.

Depending on circumstances, the front surface of the connection unit 200, at which the manipulation unit 300 is disposed, may be a curved surface having a radius of curvature that is curved rearwards. The manipulators of the manipulation unit 300 disposed at the front surface of the connection unit 200 may be located within the front view range of the driver and therefore, the driver may more easily and comfortably recognize the manipulators.

For example, the front surface of the connection unit 200, at which the manipulation unit 300 is disposed, may be a curved surface having a first radius of curvature that is curved rearwards, and the rear surface of the connection unit 200, which is opposite the front surface of the connection unit 200, may be a curved surface having a second radius of curvature that is curved rearwards. However, the present invention is not limited thereto. The first radius of curvature of the front surface may be greater than the second radius of curvature of the rear surface.

In particular, the connection unit 200 may exhibit structural rigidity, whereby the connection unit 200 may be prevented from being broken or separated even when external impact is applied. In addition, the side surface of the connection unit 200 that faces the steering column 10 may be a curved surface having a radius of curvature that is curved outwards. The manipulators of the manipulation unit 300 disposed at the connection unit 200 may be located along the circumference of the steering wheel 20 within the front view range of the driver, and therefore, the driver may more easily and comfortably recognize the manipulators.

The connection unit 200 may be exposed to prevent overlap with the steering wheel 20 connected to the steering column 10. When the connection unit 200 overlaps the steering wheel 20, the manipulators of the manipulation unit 300 may be disposed at the rear of the steering wheel 20 thus causing deterioration to convenience and visibility of the driver manipulating the manipulators.

Depending on circumstances, a direction switching unit configured to rotate the manipulators in the horizontal and vertical (leftward/rightward/upward/downward directions) may be disposed at the area of the connection unit 200 to which the manipulators of the manipulation unit 300 are mounted. Accordingly, the driver may conveniently adjust information display directions of the manipulators using the direction switching unit thus improving driver convenience.

Further, each manipulator of the manipulation unit 300 may be configured to receive user input necessary to execute a specific function of the vehicle in the state of being mounted to the connection unit 200 or being separated from the connection unit 200. In particular, the manipulators may be arranged along the front surface of the connection unit 200 at regular intervals. Depending on circumstances, the manipulators may be arranged along the front surface of the connection unit 200 at irregular intervals for driver convenience.

Each manipulator may include a first switch disposed at the front thereof, a second switch located around the first switch, and a housing configured to wrap the first and second switches. The first and second switches may be different types of user input switches. However, the present invention is not limited thereto. For example, the first switch may be a touch switch, and the second switch may be a physical switch.

Particularly, the first switch may include a plurality of touch buttons, and the second switch may include a rotary switch configured to execute different functions through rotation thereof. Depending on circumstances, the first and second switches may be the same type of user input switches. In each manipulator, a plurality of user input buttons may be arranged, and the arrangement of the user input buttons may be changed by user settings to thus improve driver convenience.

Additionally, in each manipulator, a plurality of user input buttons may be arranged, and the arrangement or sizes of the user input buttons may be changed based on priority to thus improve driver convenience. For example, in each manipulator, a user input button having high priority may be disposed at a central area or may be enlarged. In each manipulator, a plurality of user input buttons may be arranged, and the user input buttons may replace user input buttons included in other manipulators unable to be used. In particular, when some of the manipulators break down or malfunctions, normal manipulators may use vehicle control functions included in the disabled manipulators.

Further, in each manipulator, a plurality of user input buttons may be arranged. When one of the user input buttons is selected, a first function of the vehicle that corresponds to the selected input button may be executed, and when at least two of the user input buttons are simultaneously selected, a second function of the vehicle that corresponds to the simultaneously selected input buttons may be executed. A possible maximum number of user input buttons for vehicle control may be provided to each manipulator to thus provide a maximum number of functions using a minimum number of manipulators thus improving overall efficiency.

Each manipulator may include a communication unit configured to communicate with another manipulator, and may be configured to transmit or receive information to or from another manipulator via the communication unit.

In the present invention, as described above, a plurality of manipulators configured to be mounted or separated may be disposed around the steering column of the vehicle, whereby it may be possible for the driver to more conveniently and safely control various functions of the vehicle. Additionally, in the present invention, it may be possible for the driver to more conveniently and safely manipulate a plurality of manipulators while holding the steering wheel. In the present invention, the manipulators may be located with the front view range of the driver who faces the front of the vehicle thus minimizing driving distraction.

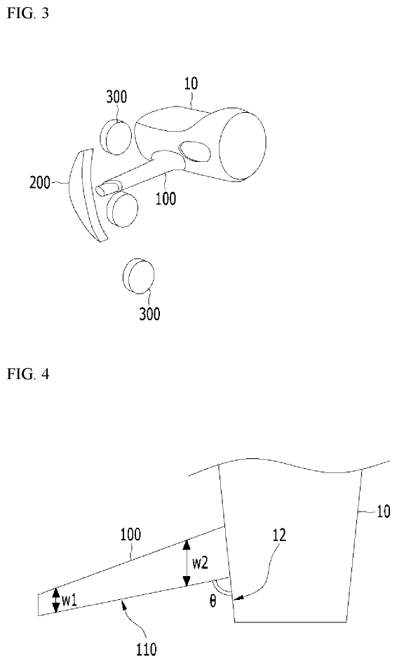

FIGS. 4 to 6 are views illustrating the support unit of the smart controller for vehicles. As shown in FIG. 4, the support unit 100 may protrude from the steering column 10 outwards. In particular, the support unit 100 may protrude in the state of being inclined such that the angle 0 between the side surface 110 of the support unit 100 that faces the steering wheel 20 and the outer surface of the steering column 10 is an acute angle.

The manipulators may be disposed concentrically toward the driver to allow the driver to more easily and conveniently manipulate the manipulators and therefore, visibility of information displayed on the manipulators may be improved, and safety may be improved. In addition, the support unit 100 may have the shape of a bar having a width that gradually increases toward the steering column 10.

For example, the support unit 100 may have a structure in which the second width w2 of the inner end of the support unit adjacent to the steering column 10 is greater than the first width w1 of the outer end of the support unit. Accordingly, the support unit 100 may be stably fixed to the steering column 10 even when external impact is applied thus preventing displacement or bending of the support unit 100.

Meanwhile, as shown in FIG. 5, a direction switching unit 150 configured to rotate the support unit 100 such that the support unit 100 is folded rearwards or unfolded forwards may be disposed at a connection area between the support unit 100 and the steering column 10. In particular, the support unit 100 may be folded such that the side surface 110 of the support unit 100 and the outer surface 12 of the steering column 10 face each other when being folded rearwards. However, the present invention is not limited thereto.

In addition, the support unit 100 may be folded rearwards by the direction switching unit 150 when the vehicle is in an autonomous traveling mode. The direction switching unit 150 may be operated in response to a driver input control single or an automatic control signal that corresponds to the autonomous traveling mode. The direction switching unit 150 may be disposed as described above because when the driver does not directly perform manual driving or when control of vehicle functions through the manipulators of the manipulation unit 300 is not necessary, the support unit 100 may be folded rearwards to secure driving space and prevent damage to the smart controller.

Meanwhile, as shown in FIG. 6, the support unit 100 may have at least one separation surface 130, from which a body thereof is separated when specific force is applied from the outside. In particular, in the support unit 100, the separation surface 130 of the body may be curved when the body is separated because support unit 100 may have the shape of a bar that protrudes outwards and therefore when the support unit is broken by external impact, the driver may be injured if the broken surface is sharp or the cut surface is rough.

As described above, the support unit of the present invention may have a structure capable of being folded in a direction in which driving space may be secured in an autonomous traveling mode at a connection area between a support and a shroud. In addition, the support unit of the present invention may be designed such that, when the support unit is broken due to collision at the time of accident, a sharp cut surface that may cause injury to the driver is not formed or does not reach the driver, thus preventing driver injury. For example, the support unit may be designed such that the area of the support unit located at the rear of the steering wheel, which has no possibility of inflicting bodily injury on the driver, is broken or the support unit exhibits rigidity capable of passing a collision test prescribed in regulations.

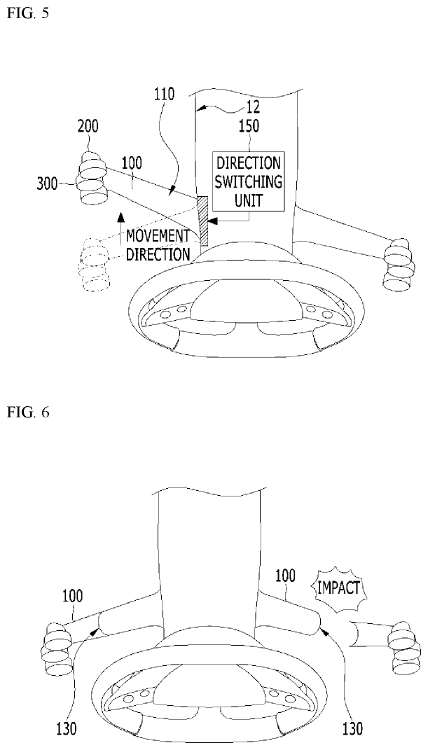

FIG. 7 is a view illustrating a process of fastening between the support unit and the connection unit of the smart controller for vehicles. As shown in FIG. 7, a fastening protrusion 102 configured to be fastened to the connection unit 200 may be formed at one end of the support unit 100. In particular, the fastening protrusion 102 may be inserted into and coupled to a fastening recess 202 of the connection unit 200.

The length of the fastening protrusion 102 may be set based on the depth of the fastening recess 202. As an example, the fastening protrusion 102 may have a screw shape to increase fastening force. In the present invention, however, various fastening devices or adhesives may be used to achieve fastening between the support unit and the connection unit, in addition to the fastening protrusion 102 and the fastening recess 202.

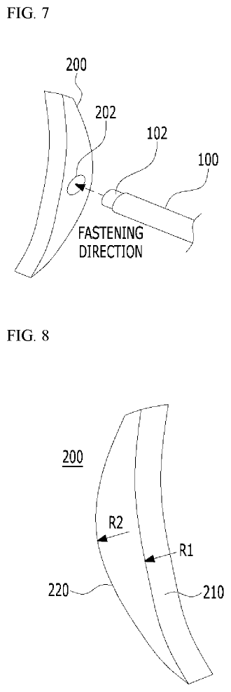

FIGS. 8 and 9 are views illustrating the connection unit of the smart controller for vehicles. As shown in FIG. 8, the front surface 210 of the connection unit 200, at which the manipulators are arranged, may be a curved surface having a radius of curvature that is curved rearwards. In particular, the manipulators disposed at the front surface of the connection unit 200 may be located within the front view range of the driver and therefore, the driver may more easily and comfortably recognize the manipulators.

For example, the front surface 210 of the connection unit 200, at which the manipulators are arranged, may be a curved surface having a first radius of curvature R1 that is curved rearwards, and the rear surface 220 of the connection unit 200, which is opposite the front surface 210, may be a curved surface having a second radius of curvature R2 that is curved rearwards. In particular, the first radius of curvature R1 of the front surface 210 may be greater than the second radius of curvature R2 of the rear surface 220. Accordingly, the connection unit 200 may exhibit structural rigidity and the connection unit 200 may be prevented from being broken or separated even when external impact is applied.

In addition, as shown in FIG. 9, the side surface 230 of the connection unit 200 that faces the steering column may be a curved surface having a radius of curvature that is curved outwards. In particular, the manipulators disposed at the connection unit 200 may be located along the circumference of the steering wheel 20 within the front view range of the driver and therefore, the driver may more easily and comfortably recognize the manipulators.

The connection unit 200 may be exposed to prevent overlap with the steering wheel 20 connected to the steering column. In other words, when the connection unit 200 overlaps the steering wheel 20, the manipulators of the manipulation unit 300 are disposed at the rear of the steering wheel 20 thus deteriorating the convenience and visibility of the driver who manipulates the manipulators may be deteriorated.

In addition, the manipulation unit 300 may be configured such that the manipulators are arranged along the front surface of the connection unit 200 at regular intervals. In other words, the distances d1 and d2 between the respective manipulators may be equal to each other. Depending on circumstances, the manipulators may be arranged at irregular intervals for driver convenience.

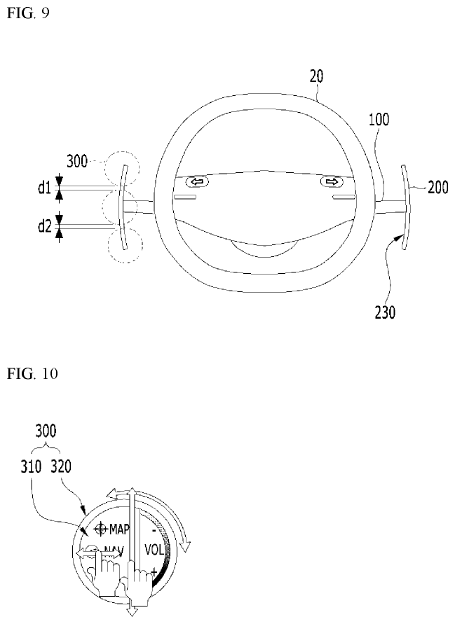

FIG. 10 is a view illustrating the manipulation unit of the smart controller for vehicles. As shown in FIG. 10, each manipulator of the manipulation unit 300 may include a first switch 310 disposed at the front thereof, a second switch 320 located around the first switch 310, and a housing configured to wrap or surround the first and second switches 310 and 320.

Particularly, the first and second switches 310 and 320 may be different types of user input switches. However, the present invention is not limited thereto. For example, the first switch 310 may be a touch switch, and the second switch 320 may be a physical switch. The first switch 310 may include a plurality of touch buttons, and the second switch 320 may include a rotary switch configured to execute different functions through rotation thereof. Depending on circumstances, the first and second switches 310 and 320 may be the same type of user input switches.

Each manipulator may be configured to perform input operations, such as leftward-rightward (e.g., horizontal) swiping, upward-downward (e.g., vertical) swiping, and touch, through a touch type display, and a plurality of functions may be used in a narrow area using the same. In each manipulator, a plurality of user input buttons may be arranged, and the arrangement of the user input buttons may be changed by user settings thus improving driver convenience. Additionally, in each manipulator, a plurality of user input buttons may be arranged, and the arrangement or sizes of the user input buttons may be changed based on priority. For example, in each manipulator, a user input button having high priority may be disposed at a central area or may be enlarged.

Further, in each manipulator, a plurality of user input buttons may be arranged, and the user input buttons may replace user input buttons included in other manipulators that are unable to be used. In other words, when some of the manipulators break down or malfunction, normal manipulators (e.g., manipulators without malfunction) may use vehicle control functions included in the disabled manipulators thus improving driver convenience.

In addition, in each manipulator, a plurality of user input buttons may be arranged. When one of the user input buttons is selected, a first function of the vehicle that corresponds to the selected input button may be executed, and when at least two of the user input buttons are simultaneously selected, a second function of the vehicle that corresponds to the simultaneously selected input buttons may executed controlled. Accordingly, a possible maximum number of user input buttons for vehicle control may be provided to each manipulator and thus, a maximum number of functions may be provided using a minimum number of manipulators, whereby efficiency may be improved.

As described above, functions of each manipulator of the present invention may be customized through user settings, in addition to basic default values, and may be mutually exchanged. Additionally, when a core function (e.g. a start button) having priority in importance or a function of another manipulator is unable to be used in error, a replaceable function may be displayed on the display.

In addition, a single screen of the manipulator may be divided into a plurality of parts, or a plurality of manipulators may be simultaneously operated by specific user input, such as multi-touch input, in order to perform a third specific function. For example, when a gathering action is performed in the state in which the thumb and an index finger are put on a first manipulator and a second manipulator arranged in the upward-downward direction, functions of the two manipulators may be swapped.

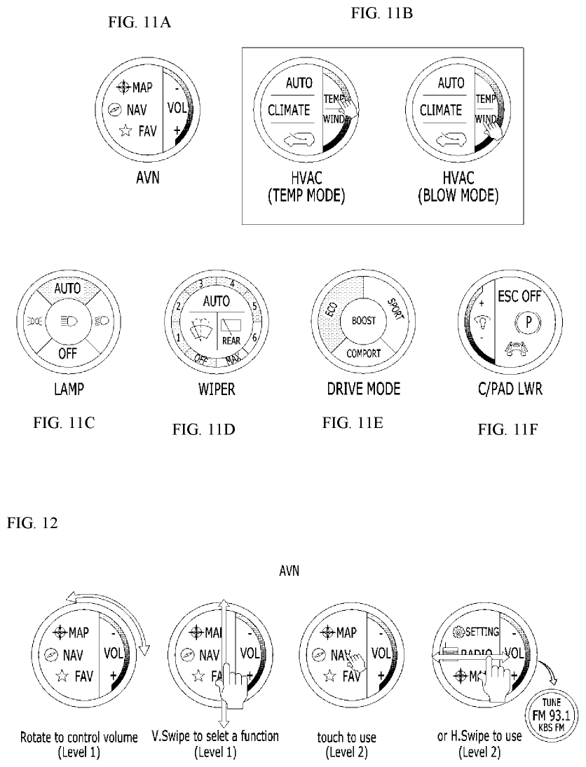

FIGS. 11A to 11F are views showing manipulators configured to control various functions of the vehicle. As shown in FIGS. 11A to 11F, each manipulator may be configured to receive user input necessary to execute a specific function of the vehicle in the state of being mounted to the smart controller or being separated from the smart controller.

In particular, the manipulator may be a control input device configured to execute various functions of the vehicle, such as an audio, video, and navigation (AVN) function, a heating, ventilation, and air conditioning (HVAC) function, a lamp function, a wiper function, a drive mode function, and a crash pad (C/PAD) LWR function. Each manipulator may include user input buttons capable of manipulating a plurality of functions in a single screen.

In the present invention, as described above, an assembly formed by arranging a plurality of manipulators vertically or along the curved surface of the steering wheel may be coupled to the support that extends from the steering column (or the shroud). A display/manipulation surface of each manipulator faces in a direction in which the driver may view the display/manipulation surface, and may be gradually adjusted to have an appropriate angle based on visibility and manipulation efficiency.

Each manipulator may have a form in which a physical rotary button is coupled to a touch display, and may have various forms, such as a touch key+rotary combination and a hard key+rotary combination. In addition, each manipulator may be manipulated while the driver holds the steering wheel, and may be located within a range within which the driver does not need to look way from the front (e.g., driving direction), thus minimizing driving distraction.

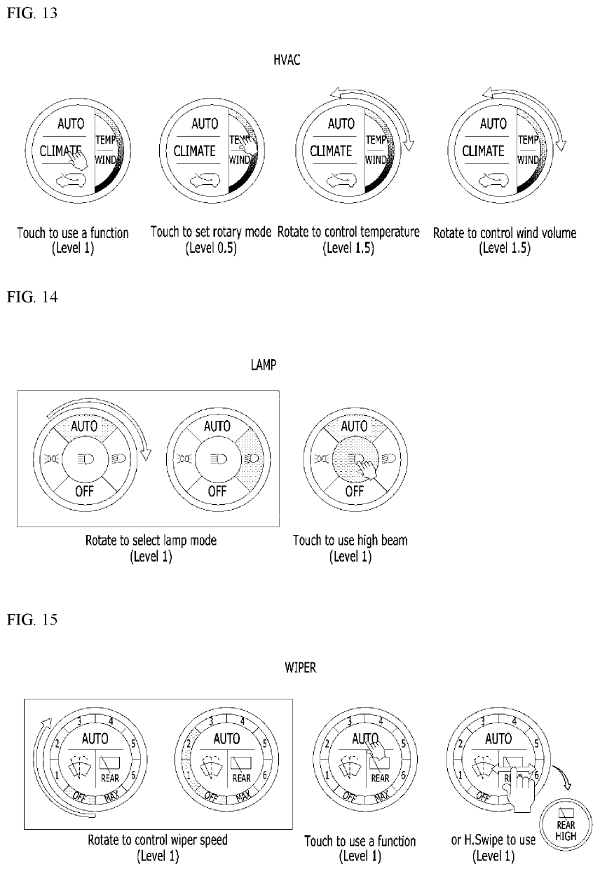

FIGS. 12 to 17 are views illustrating manipulation modes of the manipulators. As shown in FIG. 12, a manipulator configured to execute the AVN function of the vehicle may be configured to adjust volume through rotation, and select another function through upward-downward swiping. In addition, the manipulator configured to operate the AVN function of the vehicle may be configured to select a specific function through touch, and tune to a radio channel through leftward-rightward swiping.

As shown in FIG. 13, a manipulator configured to control the HVAC function of the vehicle may be configured to select a specific function through touch, and set a rotation mode through touch. In addition, the manipulator configured to execute the HVAC function of the vehicle may be configured to execute a temperature control function through rotation, and adjust the intensity of wind flowing into vehicle (e.g., for temperature control) through rotation.

As shown in FIG. 14, a manipulator configured to execute the lamp function of the vehicle may be configured to select a lamp mode function through rotation, and perform a high beam function of the lamp through touch. As shown in FIG. 15, a manipulator configured to execute the wiper function of the vehicle may be configured to adjust wiper speed through rotation, select another function through touch, and operate a rear wiper of the vehicle through leftward-rightward swiping.

As shown in FIG. 16, a manipulator configured to execute the drive mode function of the vehicle may be configured to select the drive mode function through rotation, and select the drive mode function through touch. As shown in FIG. 17, a manipulator configured to execute the crash pad (C/PAD) LWR function of the vehicle may be configured to execute a rheostat function through rotation, select another function through upward-downward swiping, and execute the selected function through leftward-rightward swiping. In the present invention, as described above, it may be possible to manipulate the manipulators through leftward-rightward swiping, upward-downward swiping, touch, and various other input operations.

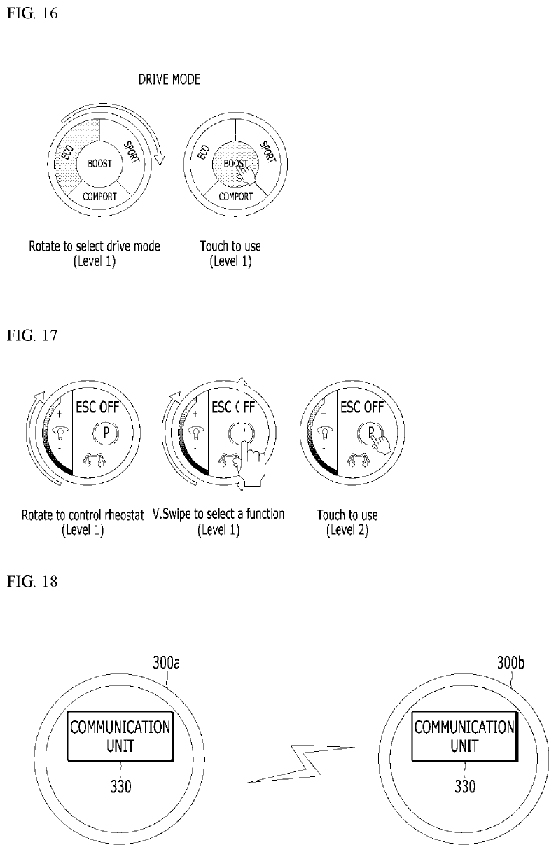

FIG. 18 is a view illustrating a communication process between the manipulators. As shown in FIG. 18, all of the manipulators may be operated by a single controller, or may be configured to wirelessly communicate with each other to exchange information or to interact with each other. Each manipulator may be separated from the connection unit of the smart controller to be utilized alone.

In particular, each manipulator may include a communication unit 330 configured to communicate with another manipulator, and transmit information to another manipulator via the communication unit 330 or receive information from another manipulator via the communication unit 330 thus improving driver convenience and usability of the manipulators.

In the present invention, as described above, the manipulators may be configured to perform wireless communication therebetween to exchange information and to interact with each other. In addition, each manipulator of the present invention may be controlled by another manipulator, or may be configured to directly operate another manipulator.

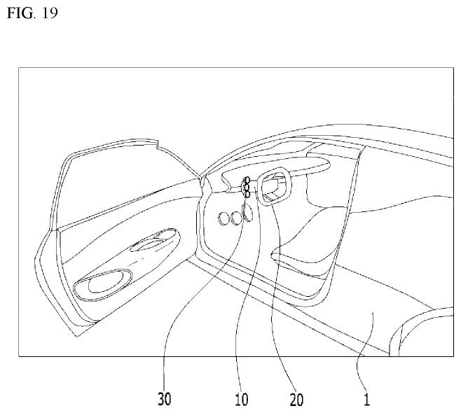

FIG. 19 is a view illustrating a vehicle including a smart controller for vehicles according to an exemplary embodiment of the present invention. As shown in FIG. 19, the vehicle 1 may include a steering column 10, a steering wheel 20 disposed at the end of the steering column 10, and a smart controller 30 connected to the steering column 10, the smart controller 30 disposed around the steering wheel 20 (e.g., in the proximate vicinity of the steering wheel).

In particular, the smart controller 30 may include a support unit that protrudes from the steering column 10 in the first direction, a connection unit that extends from the support unit in the second direction, and a manipulation unit mounted to the connection unit, the manipulation unit being disposed in the third direction. As an example, the support unit may protrude in the X-axis direction, the connection unit may extend in the Z-axis direction, and the manipulation unit may be disposed in the Y-axis direction.

The support unit of the smart controller 30 may be disposed at the rear of the steering wheel 20 disposed at the end of the steering column 10 to protrude in the state of being inclined toward the steering wheel 20. Accordingly, a plurality of manipulators may be disposed concentrically toward the driver, whereby the driver may more easily and conveniently manipulate the manipulators, visibility of information displayed on the manipulators may be improved, and safety may be improved.

In addition, a direction switching unit configured to rotate the support unit of the smart controller 30 such that the support unit is folded rearwards or unfolded forwards may be disposed at a connection area between the support unit and the steering column 10. Accordingly, when the driver does not directly perform manual driving or when control of vehicle functions through the manipulators is not necessary, the support unit may be folded rearwards to secure driving space and prevent damage to the smart controller.

As an example, the support unit may be folded rearwards by the direction switching unit when the vehicle is in an autonomous traveling mode. In addition, the support unit of the smart controller 30 may include a plurality of support bars that protrude from the steering column 10. The support bars may be disposed in symmetry.

The manipulators disposed at the connection unit fastened to the end of the support unit may be located within the front view range of the driver to allow the driver to more easily and comfortably recognize the manipulators. In addition, the front surface of the connection unit of the smart controller 30, at which the manipulation unit is disposed, may be a curved surface having a radius of curvature that is curved rearwards.

The manipulators of the manipulation unit disposed at the front surface of the connection unit may be located within the front view range of the driver thus allowing the driver to more easily and comfortably recognize the manipulators. In addition, the side surface of the connection unit of the smart controller 30 that faces the steering column 10 may be a curved surface having a radius of curvature that is curved outwards. In particular, the manipulators of the manipulation unit disposed at the connection unit may be located along the circumference of the steering wheel 20 within the front view range of the driver thus allowing the driver to more easily and comfortably recognize the manipulators.

Depending on circumstances, a direction switching unit configured to rotate the manipulators in the leftward/rightward/upward/downward directions may be disposed at the area of the connection unit of the smart controller 30 to which the manipulators of the manipulation unit are mounted. Accordingly, the driver may conveniently adjust information display directions of the manipulators using the direction switching unit thus improving driver convenience.

The manipulation unit of the smart controller 30 may be configured to receive user input necessary to execute a specific function of the vehicle in the state of being mounted to the connection unit or being separated from the connection unit. In each manipulator of the manipulation unit, a plurality of user input buttons may be arranged, and the arrangement of the user input buttons may be changed by user settings. Additionally, in each manipulator, a plurality of user input buttons may be arranged, and the arrangement or sizes of the user input buttons may be changed based on priority.

Further, in each manipulator, a plurality of user input buttons may be arranged, and the user input buttons may replace user input buttons included in other manipulators that cannot be used. A plurality of user input buttons may be arranged and when one of the user input buttons is selected, a first function of the vehicle that corresponds to the selected input button may be executed, and when at least two of the user input buttons are simultaneously selected, a second function of the vehicle that corresponds to the simultaneously selected input buttons may be executed.

Each manipulator may include a communication unit configured to communicate with another manipulator, and transmit or receive information to or from another manipulator through the communication unit. In the present invention, as described above, a plurality of manipulators configured to be mounted or separated may be disposed around the steering column of the vehicle, whereby it may be possible for the driver to more conveniently and safely control various functions of the vehicle.

Additionally, in the present invention, it may be possible for the driver to more conveniently and safely manipulate a plurality of manipulators while holding the steering wheel. In the present invention, the manipulators may be located within the front view range of the driver who faces the front of the vehicle thus minimizing driving distraction.

It will be appreciated by those skilled in the art that the effects achievable through the present invention are not limited to those that have been particularly described hereinabove and that other effects of the present invention will be more clearly understood from the above detailed description.

The above detailed description is not to be construed as limiting the present invention in any aspect, but is to be considered by way of example. The scope of the present invention should be determined by reasonable interpretation of the accompanying claims, and all equivalent modifications made without departing from the scope of the present invention should be understood as being included in the following claims.

What is claimed is:

1. A smart controller, comprising:
a support unit that protrudes from a steering column in a first direction;
a connection unit that extends from the support unit in a second direction; and
a manipulation unit mounted to the connection unit, wherein the manipulation unit is disposed in a third direction and includes a plurality of manipulators,
wherein each manipulator is configured to receive user input necessary to execute a specific function of a vehicle while being mounted to the connection unit or being separated from the connection unit.

2. The smart controller according to claim 1, wherein the support unit protrudes in an X-axis direction, the connection unit extends in a Z-axis direction, and the manipulation unit is disposed in a Y-axis direction.

3. The smart controller according to claim 1, wherein the support unit is disposed at a rear of a steering wheel disposed at an end of the steering column to protrude while being inclined toward the steering wheel.

4. The smart controller according to claim 1, wherein a direction switching unit is configured to rotate the support unit to fold the support unit rearwards or unfold the support unit forwards, and wherein the direction switching unit is disposed at a connection area between the support unit and the steering column.

5. The smart controller according to claim 4, wherein the support unit is folded rearwards by the direction switching unit when the vehicle is in an autonomous traveling mode.

6. The smart controller according to claim 1, wherein a fastening protrusion configured to be fastened to the connection unit is formed at one end of the support unit.

7. The smart controller according to claim 1, wherein the support unit includes a plurality of support bars that protrude from the steering column, and wherein the support bars are disposed in symmetry.

8. The smart controller according to claim 1, wherein a fastening recess is formed in a side surface of the connection unit fastened to the support unit.

9. The smart controller according to claim 1, wherein a front surface of the connection unit, at which the manipulation unit is disposed, is a curved surface having a radius of curvature that is curved rearwards.

10. The smart controller according to claim 1, wherein a side surface of the connection unit that faces the steering column is a curved surface having a radius of curvature that is curved outwards.

11. The smart controller according to claim 1, wherein the plurality of manipulators are arranged along a front surface of the connection unit at predetermined intervals.

12. The smart controller according to claim 1, wherein each manipulator includes:
a first switch disposed at a front thereof;
a second switch located proximate to the first switch; and
a housing configured to surround the first and second switches.

13. The smart controller according to claim 12, wherein the first and second switches are different types of user input switches.

14. The smart controller according to claim 1, wherein each manipulator includes a plurality of user input buttons and an arrangement of the user input buttons is changed by user settings.

15. The smart controller according to claim 1, wherein each manipulator includes a plurality of user input buttons and an arrangement or sizes of the user input buttons are changed based on priority.

16. The smart controller according to claim 15, wherein a user input button having high priority is disposed at a central area or is enlarged.

17. The smart controller according to claim 1, wherein each manipulator includes a plurality of user input buttons and the user input buttons replace user input buttons included in manipulators of the plurality of manipulators that are disabled.

18. The smart controller according to claim 1, wherein each manipulator includes a plurality of user input buttons is arranged, when one of the user input buttons is selected, a first function of the vehicle that corresponds to the selected input button is executed, and when at least two of the user input buttons are simultaneously selected, a second function of the vehicle that corresponds to the simultaneously selected input buttons is executed.

19. The smart controller according to claim 1, wherein each manipulator includes a communication unit configured to communicate with another manipulator, and is configured to transmit or receive information to or from another manipulator through the communication unit.

20. A vehicle, comprising:
a steering column;
a steering wheel disposed at an end of the steering column; and
a smart controller connected to the steering column, wherein the smart controller is disposed in a vicinity of the steering wheel,
wherein the smart controller includes:
a support unit that protrudes from the steering column in a first direction;
a connection unit that extends from the support unit in a second direction; and
a manipulation unit mounted to the connection unit and disposed in a third direction, wherein the manipulation unit includes a plurality of manipulators,
wherein each manipulator is configured to receive user input necessary to execute a specific function of the vehicle while being mounted to the connection unit or being separated from the connection unit.
